(19) United States
(12) Patent Application Publication
(10) Pub. No.: US 2015/0124863 A1
(43) Pub. Date: May 7, 2015

(54) CHROMA-BASED VIDEO CONVERTER

(71) Applicant: ClearOne Inc., Salt Lake City, UT (US)

(72) Inventor: Avishay Ben Natan, Hod Hasharon (IL)

(73) Assignee: ClearOne Inc., Salt Lake City, UT (US)

(21) Appl. No.: 14/286,301

(22) Filed: May 23, 2014

Related U.S. Application Data
(60) Provisional application No. 61/828,626, filed on May 29, 2013.

(51) Int. Cl. H04N 19/186

(52) U.S. Cl. CPC H04N 19/186
USPC 375/240.02

(57) ABSTRACT

This disclosure describes a method and system for encoding an RGB24 video signal (504) having multiple video frames. An RGB video frame is received and is split into red, green, and blue data. The received RGB video frame is converted into a first YUV frame (508-1) having Y data same as the red data and a second YUV frame (508-2) having Y data same as the green data. The blue data is segmented into a first data segment having 0-127 values and a second data segment having 128-255 values of the blue color component. The first data segment and the second data segment are embedded as the UV data of the first YUV frame (508-1) and the second YUV frame (508-2) respectively. The first YUV frame (508-1) and the second YUV frame (508-2) are encoded based on a timestamp same as that associated with the received RGB frame.

### CROSS REFERENCE TO RELATED APPLICATIONS

This application claims priority and the benefits of the earlier filed Provisional USAN 61/828,626, filed May 29, 2013, which is incorporated by reference for all purposes into this specification.

### TECHNICAL FIELD

The present disclosure relates generally to image processing. More particularly, this disclosure relates to image encoders and related methods.

### BACKGROUND ART

A video is made up of multiple still frames or images having pixels, each of which has a specific luminance and chrominance. The luminance refers to pixel brightness and its contrast within a particular video frame or image, and the chrominance refers to the color and the intensity of that color represented in each pixel. The color information is often minimized to reduce the pixel data size for storing or broadcasting uncompressed digital video data, thereby reducing the required bit stream bandwidth. Such reduction of color information is called Chroma subsampling, which does not affect the perceived quality of the video frame or an image because the human eye is relatively more sensitive to luminance than chrominance in the video or an image.

Chroma subsampling involves selection of a set of pixels to determine Chroma information, which is representative of the selected set of pixels while maintaining the luminance information for the selected pixels. Chroma subsampling is expressed as a ratio of pixels defining a sampling region with respect to the number of pixels being sampled from each row of that sampling region. Typically, the ratio is represented as J:a:b, where ‘J’ represents the total number of pixels in the horizontal sampling region, ‘a’ represents the number of pixels sampled in the first row of pixels as defined by the horizontal sampling region ‘J’, and ‘b’ represents the number of pixels sampled in the second row of pixels in the ‘J’ region. ‘a’ and ‘b’ refer to the vertical resolution, which is sampled across the ‘J’ horizontal sampling region.

Digital video signals pertaining to any color space (for e.g., PAL, NTSC, SECAM, sRGB, BT.709, YUV, etc.) or color models (for e.g., RGB, Y′UV, YPbPr, etc.) may be encoded to various Chroma subsampling ratios such as (4:2:2), (4:2:0), and (4:4:4). For example, with reference to the YUV color space, the (4:2:0) video format involves one U (or Cb) Chroma sample and one V (Cr) Chroma sample for every four Y (or Luma) samples; the (4:2:2) video format involves U and V Chroma samples subsampled at half the Y Luma resolution; and the (4:4:4) video format involves the U and V Chroma samples being sampled at a resolution same as the Y Luma samples.

The (4:4:4) video format provides the best quality video, however a correspondingly video being generated by a video encoder has a large data size video, thereby increasing the storage cost and required bandwidth for broadcast. As a result, commonly used video encoders support lower Chroma subsampling such as (4:2:2), (4:2:0), etc. to generate lower quality video data, which is undesirable for detail-intensive or sensitive applications involving medical data, military data, astronomical data, etc.

As such, it is beneficial to optimize video quality without increasing the video data size.

### SUMMARY OF INVENTION

This disclosure describes a Chroma-based video converter. In one exemplary embodiment, a method for encoding a video signal in RGB24 format having multiple RGB frames is provided. Each RGB frame comprises 8 bits per pixel for red, green, and blue color components. The video signal may be received from a source device. The method comprises a step of receiving at least one RGB frame from the multiple RGB frames. The at least one RGB frame may be split into R data for the red color component, G data for the green color component, and B data for the blue color component. The method further comprises converting the received at least one RGB frame into a first YUV frame and a second YUV frame, in which the R data may be embedded as a Y data of the first YUV frame, the G data may be embedded as a Y data of the second YUV frame, and the B data may be segmented into a first data segment having 0-127 values of the blue color component and a second data segment having 128-255 values of the blue color component. The first data segment may be embedded as a UV data of the first YUV frame and the second data segment may be embedded as a UV data of the second YUV frame. The method also comprises encoding the first YUV frame and the second YUV frame based on a timestamp same as that associated with the at least one RGB frame.

Another exemplary embodiment provides a non-transitory computer readable medium storing a program causing a computer to execute a process for encoding a video signal in RGB24 format, where the video signal has multiple RGB frames. Each RGB frame comprises 8 bits per pixel for red, green, and blue color components. The video signal may be received from a source device. The process comprises receiving at least one RGB frame from the multiple RGB frames. The at least one RGB frame may be split into R data for the red color component, G data for the green color component, and B data for the blue color component.

The process further comprises converting the received at least one RGB frame into a first YUV frame and a second YUV frame, in which the R data may be embedded as the Y data of the first YUV frame, the G data may be embedded as the Y data of the second YUV frame, and the B data may be segmented into a first data segment having 0-127 values of the blue color component and a second data segment having 128-255 values of the blue color component. The first data segment may be embedded as a UV data of the first YUV frame and the second data segment may be embedded as a UV data of the second YUV frame. Further yet, the method comprises encoding the first YUV frame and the second YUV frame based on a timestamp same as that associated with the at least one RGB frame.

In still another embodiment, a system for encoding a video signal in RGB24 format having a plurality of RGB frames may be provided. Each of the plurality of RGB frames comprises 8 bits per pixel for red, green, and blue color components. The system may comprise a source device, a Chroma-based video converter, and a target device. The source device may provide the video signal for being encoded. The Chroma-based video converter comprises a frame splitter, a framing module, an encoder, and a multiplexer. The frame splitter may be configured to receive at least one RGB frame from the plurality of RGB frames. The frame splitter may split the at least one RGB frame into R data for the red color component, G data for the green color component, and B data for the blue color component. The framing module may be configured to convert the received at least one RGB frame into a first YUV frame and a second YUV frame in which the R data may be embedded as the Y data of the first YUV frame, the G data may be embedded as the Y data of the second YUV frame, and the B data may be segmented into a first data segment having 0-127 values of the blue color component and a second data segment having 128-255 values of the blue color component.

The first data segment may be embedded as a UV data of the first YUV frame and the second data segment may be embedded as a UV data of the second YUV frame. The encoder may be configured to encode the first YUV frame and the second YUV frame based on a timestamp same as that associated with the at least one RGB frame. The multiplexer may be configured to multiplex the encoded first YUV frame and the encoded second YUV frame to generate a single encoded signal. The target device may be configured to at least one of receive, store and display the generated single encoded signal.

The Chroma-based video converter may further comprise a deframing module and a frame assembler. The deframing module may be configured to (1) extract the Y data corresponding to the R data and the first data segment corresponding to 0-127 values of the B data from the first YUV frame; (2) extract the Y data corresponding to the G data and the second data segment corresponding to 128-255 values of the B data from the second YUV frame; (3) combine the extracted first data segment and the second data segment to obtain a complete B data; and (4) assemble the extracted R data, the extracted G data, and the complete B data based on the timestamp to generate the at least one RGB frame.

Still another aspect of the present disclosure comprises the first YUV frame being identical to the second YUV frame.

Yet another aspect of the present disclosure comprises both the first YUV frame and the second YUV frame being in NV12 format.

Other and further aspects and features of the disclosure will be evident from reading the following detailed description of the embodiments, which are intended to illustrate, not limit, the present disclosure.

### BRIEF DESCRIPTION OF DRAWINGS

To further aid in understanding the disclosure, the attached drawings help illustrate specific features of the disclosure and the following is a brief description of the attached drawings:

FIG. 1 provides a schematic that illustrates a first network environment implementing an exemplary Chroma-based video converter, according to an embodiment of the present disclosure.

FIG. 2 provides a schematic that illustrates a second network environment implementing the exemplary Chroma-based video converter of FIG. 1, according to an embodiment of the present disclosure.

FIG. 3 provides a schematic that illustrates a third network environment implementing the exemplary Chroma-based video converter of FIG. 1, according to an embodiment of the present disclosure.

FIG. 4 provides an exemplary Chroma-based video converter of FIG. 1, according to an embodiment of the present disclosure.

FIG. 5 provides a block diagram illustrating an exemplary method of encoding an input video signal using the Chroma-based video converter of FIG. 1, according to an embodiment of the present disclosure.

FIG. 6 provides a block diagram illustrating an exemplary method of decoding the encoded input video signal of FIG. 5 using the Chroma-based video converter of FIG. 1, according to an embodiment of the present disclosure.

FIG. 7 provides a schematic that illustrates NV12 frames in the encoded video signal of FIG. 5, according to an embodiment of the present disclosure.

### DISCLOSURE OF EMBODIMENTS

The present disclosure describes numerous specific details in order to provide a thorough understanding of the present invention. One skilled in the art will appreciate that one may practice the present invention without these specific details. Additionally, this disclosure does not describe some well-known items in detail in order not to obscure the present invention.

### Non-Limiting Definitions

The ‘source device’ is used in the present disclosure in the context of its broadest definition. The source device refers to an imaging unit or any computing device capable of generating time-varying sequence of images over one or more imaging channels. Examples of the imaging unit may include, but are not limited to, a camera, a webcam, a magnetic resonance imaging (MRI) scanner, a near-infrared (NIR) illuminator, an echocardiogram, etc. Examples of the computing device may include, but are not limited to, a server, a satellite, a desktop PC, a notebook, a workstation, a personal digital assistant (PDA), a mainframe computer, a mobile computing device, an internet appliance, and so on.

The ‘target device’ is used in the present disclosure in the context of its broadest definition. The target device refers to a networked computing device configured to store or display, or both, a received image or sequence of images. Various examples of the target device comprise a desktop PC, a personal digital assistant (PDA), a server, a mainframe computer, a mobile computing device (for e.g., mobile phones, laptops, etc.), an internet appliance, etc.

The image files contemplated herein may be any digital image format capable of being interpreted by a computer or computing device. Examples of image files contemplated herein may comprise, but are not limited to JPEG, GIF, TIFF, PNG, Bitmap, RAW, PNM, WEBP, and the like.

### Exemplary Embodiments

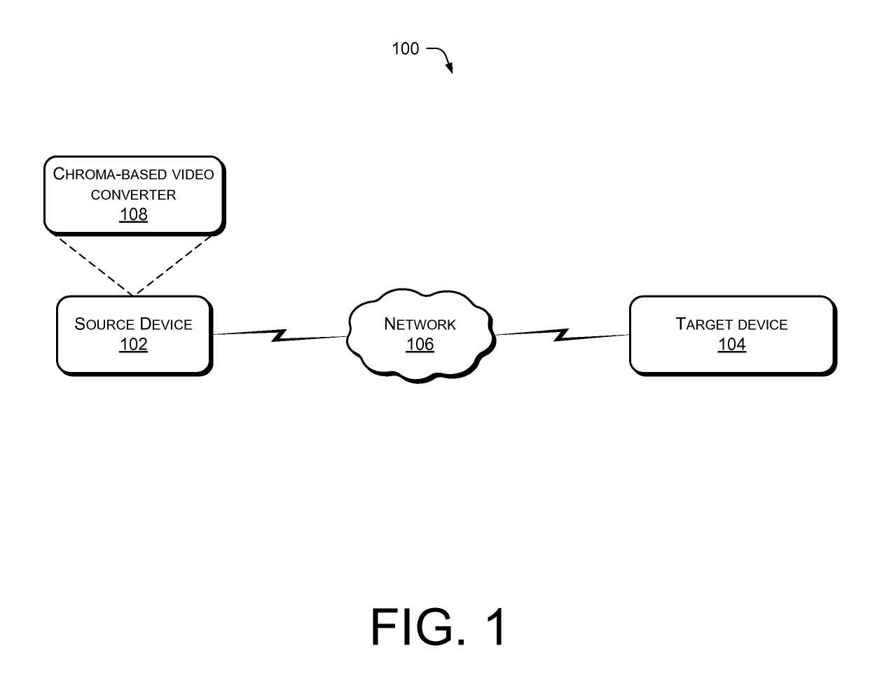

FIG. 1 is a schematic that illustrates a first network environment implementing an exemplary Chroma-based video converter, according to an embodiment of the present disclosure. The network environment 100 may comprise a source device 102 communicating with a target device 104 via a network 106. The network 106 may comprise, for example, one or more of the Internet, Wide Area Networks (WANs), Local Area Networks (LANs), analog or digital wired and wireless telephone networks (e.g., a PSTN, Integrated Services Digital Network (ISDN), a cellular network, and Digital Subscriber Line (xDSL)), radio, television, cable, satellite, and/or any other delivery or tunneling mechanism for carrying data.

In one embodiment, the network 106 may comprise multiple networks or sub-networks, each of which may comprise, for example, a wired or wireless data pathway. In another embodiment, the network 106 may comprise a circuit-switched voice network, a packet-switched data network, or any other network that is able to carry electronic communications. By way of example, the network 106 may comprise networks based on the Internet protocol (IP) or asynchronous transfer mode (ATM), and may support voice using, for example, VoIP, Voice-over-ATM, or other comparable protocols used for voice data communications. In a further embodiment, the network 106 may comprise a cellular telephone network configured to enable exchange of textual data, audio data, video data, or any combination thereof between the source device 102 and the target device 104.

The source device 102 may be configured to provide video signals in any of the known, related art, or later developed formats having a single bit stream or multi-layer bit streams of different resolutions depending upon an intended application. In one embodiment, the source device 102 may be configured to provide the video signal in RGB24 format having 8 bits per pixel (bpp) for each color component, namely, red, green, and blue, in each video frame of the video signal. The video signal may belong to any known, related art, or later developed color space or color model.

Each bit stream in the RGB24 video signal may be preconfigured to have identical Chroma or color resolution to maintain a consistent video quality. For example, the RGB24 video signal may have a Chroma subsampling ratio such as (4:2:2) representing Chroma components Cb, Cr having identical resolution of ‘2’, (4:4:4) representing Chroma components Cb, Cr that have identical resolution of ‘4’, and so on.

The video signal may be sent to a Chroma-based video converter 108 configured to use full color resolution data of the received video signal, such as, Cb, Cr data, to encode the video signal into multiple bit streams of any uneven color space such as YUV (4:2:0), YUV (4:2:2), YUV (4:1:1), etc. to provide high quality video encoding with efficient codec and bandwidth utilization.

Dynamic range of a signal may be defined as the difference between its maximum light intensity (referring to a reference white level of the signal) and the minimum light intensity (referring to a reference black level of the signal). For example, the RGB24 video signal having 8 bits being assigned for each of the R (i.e., red), G (i.e., green), and B (i.e., blue) components. The dynamic range of the RGB24 video signal for each component may vary from 0 through 255 light levels, where 0 may correspond to the reference black level and 255 may correspond to the reference white level.

The dynamic range of an encoder may be determined based on a combination of light intensity ranges corresponding to the signal-to-noise ratio (SNR) and the headroom. SNR range may refer to a range of light intensities from 0 to a peak white level, which may be relatively lesser than the reference white level of a received signal. The headroom range may refer to a range of light intensities from the peak white level to the reference white level of the received signal. Various video coding standards define such headroom so as to accommodate unpredictable filter transients and signal spikes for standardizing the performance of different encoders. For example, the BT.709 video coding standard defines headroom of an encoder to range from a peak white level of 236 through 254 for an 8-bit signal, where 0 corresponds to a reference black level and 255 corresponds to a reference white level of the signal. As such, an increase in the headroom may decrease the SNR, and vice versa. Encoder performance may be expressed by the number of video frames encoded per second for given encoder settings.

The Chroma-based video converter 108 may be configured to employ the available headroom of various software or hardware-based encoders to encode the video signal into any Chroma subsampling ratio for any color space such as YUV. The available headroom allows for encoding additional number of video frames per second simultaneously with the encoder performance required for real-time image or video transmission or storage. As such, the encoder headroom may be referred to as performance headroom, which may be manipulated by the Chroma-based video converter 108 when the resolution of the encoded output signal is low.

For instance, Intel's HD4000 based Quick Sync Video encoder encodes 1080p video at approximately 200 frames per second, with the Chroma sub sampling set to 4:2:0. The 4:2:0 format is the only supported format for this encoder. In this example, the performance headroom may be approximately 140 frames per second for the 1080p60 video.

In another example, when the resolution of the same Intel's encoder is set to Standard Definition video, the encoder is capable of approximately 1000 frames per second, which may be around 970 frames per second due to the performance headroom.

Such availability in performance headroom may be used to encode additional data, which may otherwise be unavailable. In one embodiment, in the case of (4:4:4) Chroma sub sampling ratio, additional color samples may be encoded as a separate data stream and used in order to create the original (4:4:4) bit stream. However, a person having ordinary skill in the art would understand that (4:4:4) (24 bits RGB) samples must be available as an input to create the (4:4:4) bit stream of an encoded output signal.

The same approach may be used to increase supported resolution beyond any encoder's specification. For example: an encoder supporting 1080p at 200 frames per second may be used to encode 4K*2K video at 30 frames per second. Such output signal encoded, for example, in YUV format, may be transmitted to the target device 104 over the network 106.

The Chroma-based video converter 108 may represent any devices that may be configured to encode multiple bit streams of the received video signal based on color resolution data. In one embodiment, the Chroma-based video converter 108 may be implemented as a standalone “black box” as a computing device having software installed. In another embodiment, the Chroma-based video converter 108 may be implemented as a software application or a device driver.

The Chroma-based video converter 108 may enhance or increase the functionality and/or capacity of the network 106 with which it may be in communication. The Chroma-based video converter 108 may be configured, for example, to perform e-mail tasks, security tasks, network management tasks comprising IP address management, and other tasks. In some embodiments, the Chroma-based video converter 108 may be configured to expose its computing environment or operating code to an end user, and may comprise related art I/O devices, such as a keyboard or display. The Chroma-based video converter 108 of some embodiments may, however, comprise software, a firmware or other resources that support remote administration and/or maintenance of the Chroma-based video converter 108.

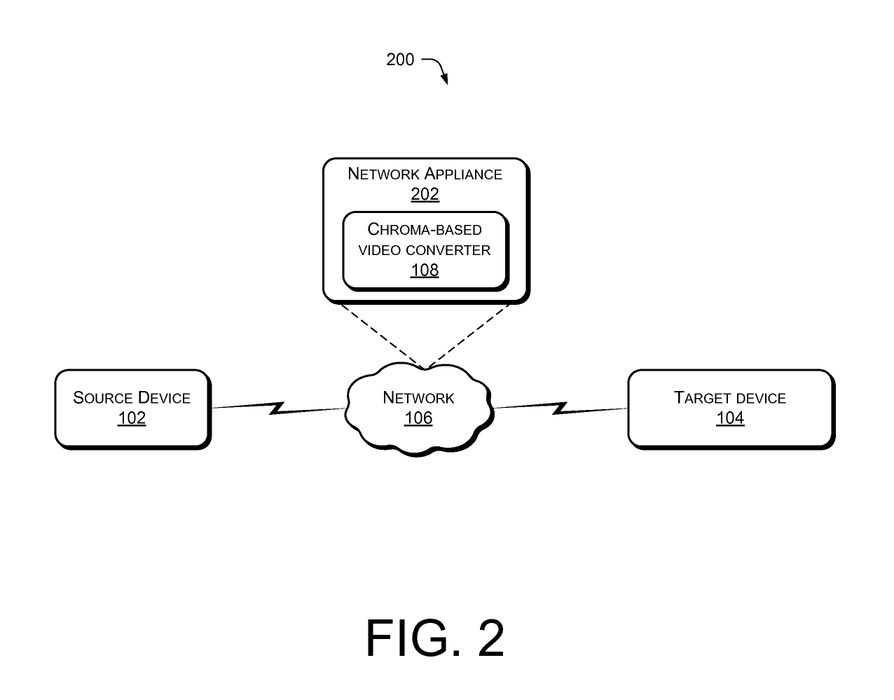

Turning now to FIG. 2, the system 200 may comprise a network appliance 202. The Chroma-based video converter 108 may be integrated with, or installed on the network appliance 202 which may be used to establish the network 106 between the source device 102 and the target device 104. The network appliance 202 may be capable of operating as an interface device for exchanging software instructions and data between the source device 102 and the target device 104. In some embodiments, the network appliance 202 may be preconfigured or dynamically configured to comprise the Chroma-based video converter 108 integrated with other devices. For example, the Chroma-based video converter 108 may be integrated with the target device 104 or any other device (not shown) connected to the network 106. The target device 104 may comprise a module (not shown), which enables that target device 104 being introduced to the network appliance 202, thereby enabling the network appliance 202 to invoke the Chroma-based video converter 108 as a service. The network appliance 202 contemplated herein may include, but is not limited to, a DSL modem, a wireless access point, a router, a base station, or a gateway having a predetermined computing power sufficient for implementing the Chroma-based video converter 108.

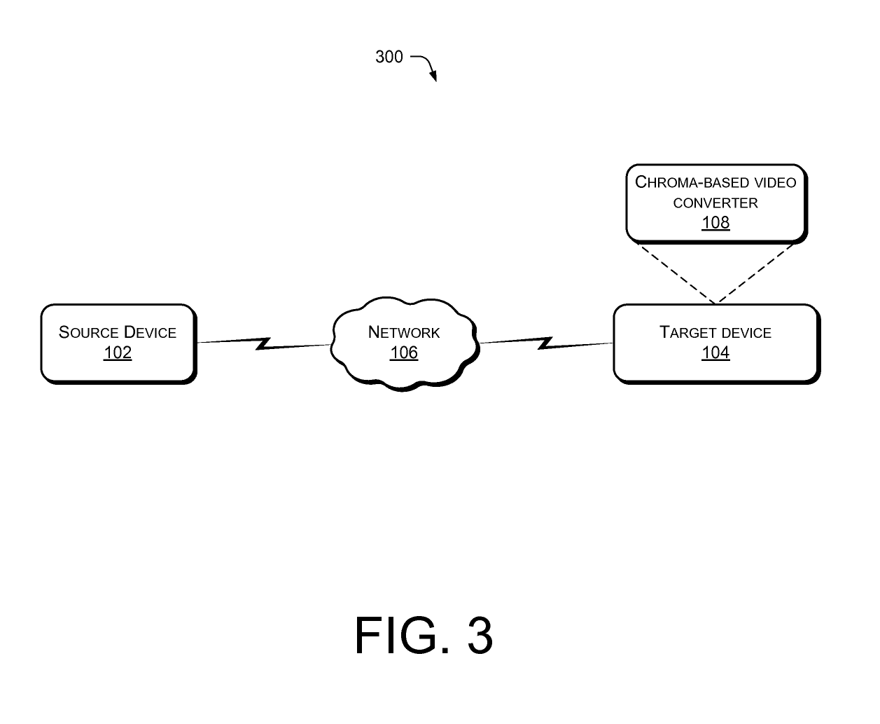

In FIG. 3, a system 300 shows an integration of the Chroma-based video converter 108. The Chroma-based video converter 108 may be integrated with, or installed on, the target device 104, which receives video from the source device 102 through the network 106. In some embodiments, the Chroma-based video converter 108 may be implemented as an intermediate device in the target device 104. The video signal within the target device 104, which may involve identical color components, may be adapted and transmitted for display according to the display capabilities of the target device 104. Devices that can implement the disclosed Chroma-based video converter 108 comprise, but are not limited to, set-top boxes, base transceiver systems (BTS), portable storage devices (for e.g., portable USB storage drive, portable hard disk, etc.), computing devices, televisions, mobile phones, laptops, personal digital assistants (PDAs), and the like, which can be employed in a variety of applications such as streaming, conferencing, or surveillance.

In another embodiment, the Chroma-based video converter 108 may be equipped with a bit stream extractor (not shown) that receives information regarding the resolution supported by the target device 104. The bit stream extractor may extract the bit streams corresponding to the supported resolution from the multi-layer bit streams of the output video signal and transmits the extracted bit streams to the target device 104. The extracted bit streams may be then decoded and rendered at the target device 104. In a further embodiment, the bit stream extractor may be integrated or installed on the target device 104.

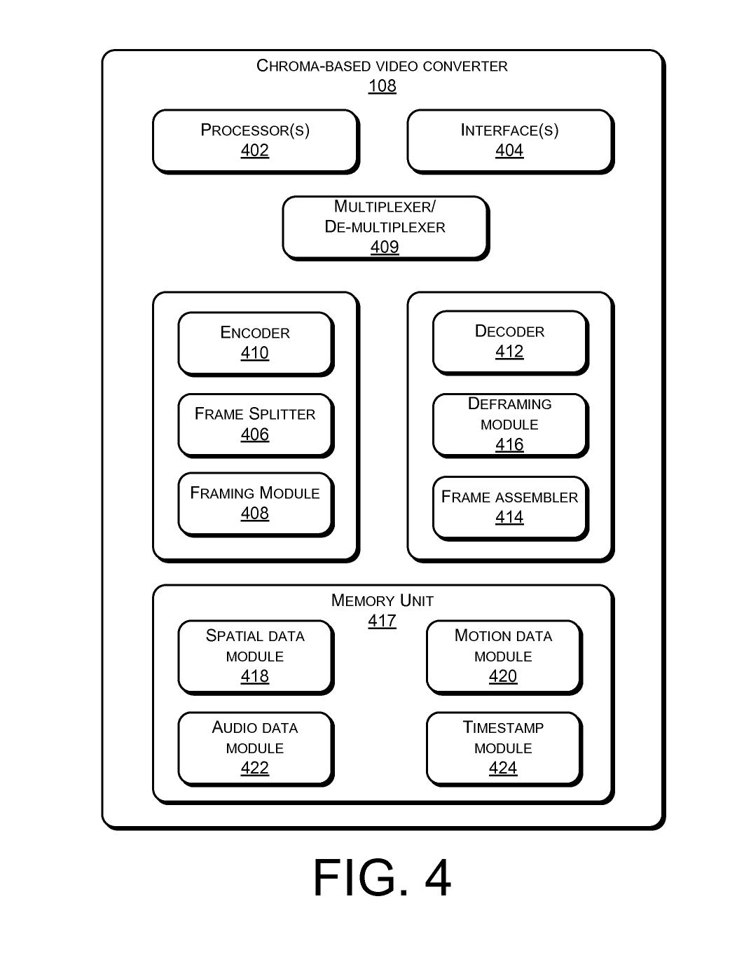

FIG. 4 illustrates an exemplary Chroma-based video converter, according to an embodiment of the present disclosure. The Chroma-based video converter 108 may comprise one or more processor(s) 402, one or more interface(s) 404, an encoder 410, a decoder 412, a multiplexer/de-multiplexer 409, a frame splitter 406, a framing module 408, a frame assembler 414, a deframing module 416, and a memory unit 417 having a timestamp module 424.

In this embodiment, the processor(s) 402 may execute machine readable program instructions for manipulating the received video signal. The processor(s) 402 may comprise, for example, microprocessors, microcomputers, microcontrollers, digital signal processors, central processing units, state machines, logic circuits, and/or any devices that manipulate signals based on operational instructions. The Chroma-based video converter 108 may further comprise, in whole or in part, a software application working alone or in conjunction with one or more hardware resources. Such software applications may be executed by one or more processors on different hardware platforms or emulated in a virtual environment. Aspects of the Chroma-based video converter 108 may leverage known, related art, or later developed off-the-shelf software. Among other capabilities, the processor(s) 402 may be configured to fetch and execute computer readable instructions in the memory unit 417. The memory unit 417 may be a non-transitory computer readable medium.

The interface(s) 404 may coordinate interactions of the Chroma-based video converter 108 with at least one of the source device 102, the target device 104, and the network appliance 202 over the network 106. The interface(s) 404 may comprise a variety of known, related art, or later developed interfaces, comprising software interfaces, for example, an application programming interface, a graphical user interface, etc.; hardware interfaces, for example, cable connectors, scanners, display screens, etc.; or both. The interface(s) 404 facilitate receiving of the video signal and reliable transmission of an encoded output video signal.

The frame splitter 406 may be configured to split each frame of the input video signal into basic color planes. For example, when the input video signal is in RGB24 format, each video frame may be split into an R plane corresponding to the red color in the video frame, a G plane corresponding to the green color in the video frame, and a B plane corresponding to the blue color in the video frame. Each of the R, G, and B planes comprise 8 bpp data values ranging from 0-255.

The framing module 408 may be configured to convert the input video signal into a YUV signal corresponding to a signal represented in YUV color space defining underlying image or frame data using luminance (Y) and chrominance (U, V) values. The YUV signal may comprise two identical YUV frames of specific Chroma subsampling format such as YUV (4:2:0) (also referred to as NV12 frames). The generated NV12 frames may be correlated to each other using a timestamp referring to the time when the corresponding RGB video frame in the input video signal was received by the video converter 108. The generated first NV12 frame may comprise the 8-bit R plane data embedded as the Y luminance data and a first half of the B plane data corresponding to values ranging from 0-127 embedded as the UV chrominance data. The generated second NV12 frame may comprise the 8-bit G plane data embedded as the Y luminance data and a second half of the B plane data corresponding to values ranging from 128-255 embedded as the UV chrominance data.

The encoder 410 may be configured to encode the generated identical YUV frames, such as the first NV12 frame and the second NV12 frame, to generate the corresponding bit streams separately. Each of a first bit stream corresponding to the first NV12 frame and a second bit stream corresponding to the second NV12 frame may be compressed using any of the variety of known, related art, or later developed compression techniques.

The encoded bit streams of the first and the second NV12 frames may be fed to the multiplexer/de-multiplexer 409, which multiplexes the encoded NV12 frames (or the modified YUV signals) into a single encoded output video signal. The encoded output signal exhibits the complete color information of the RGB input signal by accommodating the color information in separate NV12 frames.

The decoder 412 may be configured to decode a compressed and encoded video signal having the YUV format bit streams such as the NV12 bit stream. The deframing module 416 may be configured to receive the de-multiplexed encoded signal having the first NV12 frame and the second NV12 frame. The deframing module 416 decodes the first and the second NV12 frames separately. The first NV12 frame may be decoded to obtain the R data embedded as the Y data and a first set of B data embedded as the UV data in the first NV12 frame. Similarly, the second NV12 frame may be decoded to obtain the G data embedded as the Y data and a second set of B data embedded as the UV data in the second NV12 frame.

The frame assembler 414 may be configured to combine the obtained R data, G data, and B data based on the timestamp associated with the first NV12 and the second NV12 frames. In one example, the combined R, G, B data may be used to generate a 24 bit RGB frame having 8 bpp for each of the R, G, B color planes.

The memory unit 417 may comprise any non-transitory computer-readable medium known in the art, comprising, for example, volatile memory (e.g., RAM) and/or non-volatile memory (e.g., flash, etc.). In one embodiment, the memory unit 417 may comprise a spatial data module 418, a motion data module 420, an audio data module 422, and the timestamp module 424. The spatial data module 418 stores the spatial data, for e.g., R data, G data, B data, picture width, picture height, and so on, in a video frame or image of the input video signal. The motion data module 420 stores the motion data such as frame rate, picture type, end of stream flag, sequence frame number, motion vectors, Intra prediction mode, the location of different components such as pixels, blocks, macroblocks (MBs) in a video frame, and so on, and other related attributes such as MB modes, MB type, MB motion type, etc. The audio data module 422 stores audio data associated with each video frame of the input video signal. The timestamp module 424 stores the time at which each video frame may be received at the encoder 410 for the input video signal.

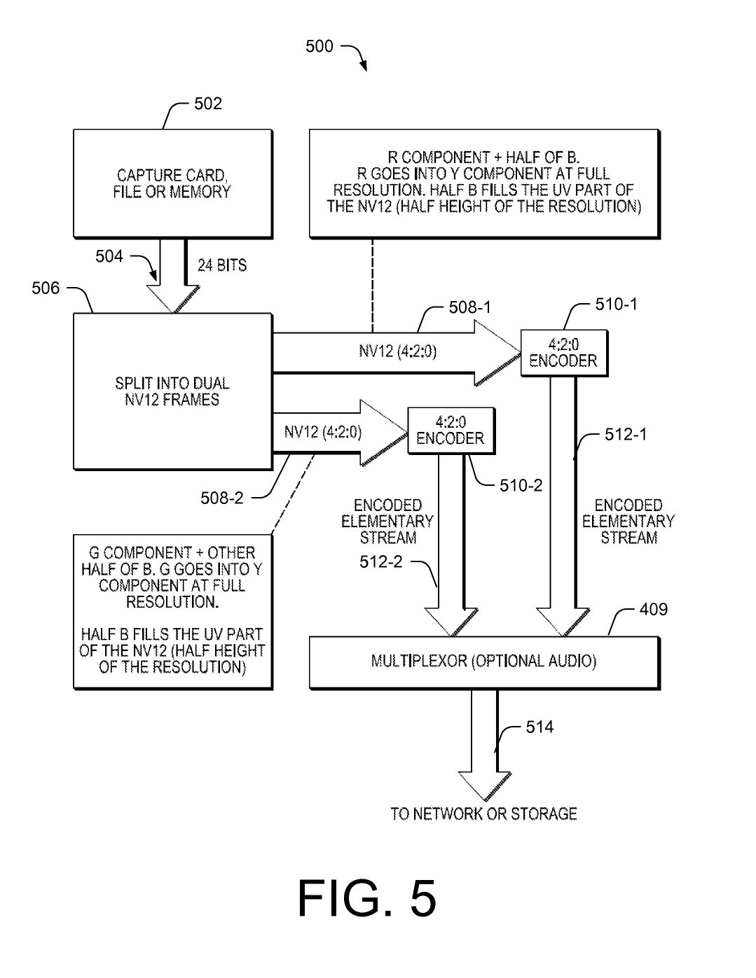

FIG. 5 is a block diagram illustrating an exemplary method 500 for encoding an input video signal using the Chroma-based video converter 108, according to an embodiment of the present disclosure. At step 502, the Chroma-based video converter 108 may be configured to receive an input video signal 504 from a capture card, stored file, or memory of the source device 102. In some embodiments, the capture card may be integrated with the video converter 108 and interact with the source device 102 for receiving the input video signal. In one example, the input video signal 504 may be the RGB24 video signal having 24 bpp of data with each 8 bpp assigned to a color component, namely, red, green, and blue.

The processor(s) 402 may segment the received input video signal 504 and its attributes such as the spatial data, the motion data, and the audio data for being stored in the spatial data module 418, the motion data module 420, the audio data module 422 respectively in the memory unit 417 either temporarily or permanently for later use. In one embodiment, the processor(s) 402 may also record the time at which a video frame of the input video signal 504 has arrived at the video converter 108 and store the recorded time as a timestamp for that video frame in the timestamp module 424.

At step 506, the input video signal 504 may be split into dual YUV frames, such as NV12 frames. The processor(s) 402 may feed the received input video signal 504 to the frame splitter 406. The frame splitter 406 may be configured to split the RGB24 video signal 504 into basic color planes such as the R-plane corresponding to the red color component, the G plane corresponding to green color component, and the B plane corresponding to the blue color component. Each of these planes comprises 8 bpp of R data, 8 bpp of G data, and 8 bpp of B data, each of the data ranging from 0-255. The R data, G data, and the B data are fed to the framing module 408.

The framing module 408 may be configured to receive the R data, G data, and the B data to generate two NV12 frames in the YUV format for each RGB video frame. The framing module 408 may utilize the R data to be embedded as the Y luminance data and the top half of the B data corresponding to values ranging from 0-127 to be embedded as the UV chrominance data to generate a first NV12 frame 508-1. In a similar manner, the framing module 408 may use the G data to be embedded as the Y luminance data and the bottom half of the B data corresponding to values ranging from 128-255 to be embedded as the UV chrominance data to generate a second NV12 frame 508-2.

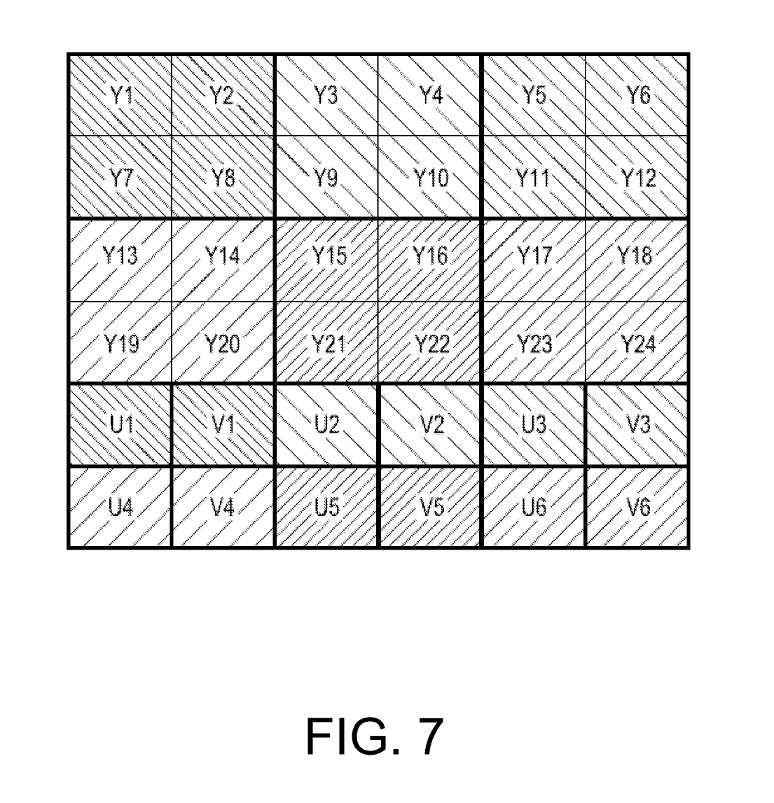

The framing module 408 further retrieves the timestamp associated with the RGB video frame from the timestamp module 424. The retrieved timestamp, which may be associated with both the NV12 frames 508-1, 508-2 (collectively, NV12 frames 508), may be used to label the dual NV12 frames 508 as a pair. The time stamped dual-NV12 frames 508 may be then separately sent to and encoded by different instances of the encoder 410. The first NV12 frame 508-1 may be sent to the encoder instance 510-1 and the second NV12 frame 508-2 may be sent to the encoder instance 510-2. The NV12 frames 508 may be stored in the memory unit 417 in a planar format as shown in FIG. 7. In the planar format, the Y luminance data may be stored first in the memory unit 417 followed by the UV chrominance data. As depicted, for each 4 Y samples, represented by the same type of shading, such as Y1, Y2, Y7, and Y8, there may be only one U sample and one V sample, such as U1 and V1, represented by the same type of shading as the Y samples. As shown, the resolution of the UV plane may be half the resolution of the Y plane.

From the encoder instances 510-1 and 510-2 (collectively, encoder instances 510), the first and the second NV12 frames 508 may be transformed to the frequency domain using a variety of transformation techniques such as discrete cosine transform (DCT). The DCT segregates the NV12 frames 508 into regions of differing frequencies based on average luminance (Y) and chrominance (U, V) values for each pixel in the NV12 frames 508.

The YUV data in the DCT transformed NV12 frames 508 may then quantized, which reduces the number of bits per pixel for representing the associated luminance and chrominance values. The encoder instances 510 then compress the YUV data in the corresponding NV12 frames 508 using any of the variety of known, related art, or later developed compression techniques such as Huffman Encoding to generate a first bit stream 512-1 for the encoded first NV12 frame 508-1 and a second bit stream 512-2 for the encoded second NV12 frame 508-2. The first and the second bit streams 512-1, 512-2 (collectively, bit streams 512) are multiplexed by the multiplexer/de-multiplexer 409 to generate a single encoded YUV signal 514 that is transmitted back on to the network or stored on a storage device.

The generated NV12 frames use the original full color resolution data to encode more than one stream of 4:2:0 (or 4:2:2 or any uneven color space). Further, embodiments are discussed to operate on an input video signal in the RGB24 format; however, the above described encoding performed by the Chroma-based video converter 108 may be applied to any color space where the resolution of all color components may be identical in a video frame.

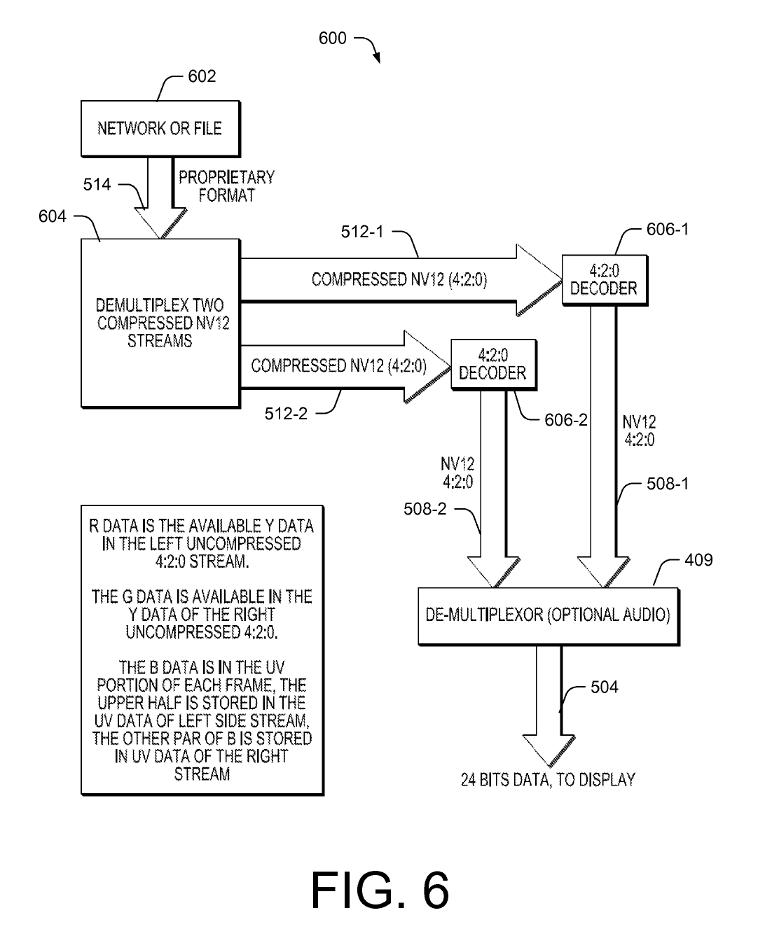

FIG. 6 is a block diagram illustrating an exemplary method 600 of decoding the encoded input video signal of FIG. 5 using the Chroma-based video converter 108 of FIG. 1. According to an embodiment of the present disclosure, at step 602, the Chroma-based video converter 108 may be configured to receive a compressed YUV encoded signal 514 having the modified dual NV12 frames 508 from a networked device such as the target device 104, source device 102, etc. At step 604, the compressed YUV encoded signal 514 may be de-multiplexed by the multiplexer/de-multiplexer 409 to generate the two compressed NV12 bit streams 512-1, 512-2. Each of the NV12 bit streams 512 may be sent to and processed by different decoder instances 606-1, 606-2 (collectively, decoder instances 606). At the decoder instances 606, the NV12 bit streams 512 may be decompressed, the underlying data may be inverse quantized, and inverse DCT may be performed to generate the NV12 frames 508-1, 508-2.

In some embodiments, the generated NV12 frames 508 may contain the audio data multiplexed with the video data (i.e., the spatial data and the motion data). The deframing module 416 may receive the first NV12 frame 508-1 and the second NV12 frame 508-2, and may extract data corresponding to the original color format in the encoded YUV output signal 514. For example, the first generated NV12 frame 508-1 may comprise the R data (corresponding to the red color component) embedded as the Y data and the top half of the B data (corresponding to the blue color component having range of values from 0-127) embedded as the UV data. Similarly, a second generated NV12 frame 508-2 may comprise the G data (corresponding to the green color component) embedded as the Y data and the bottom half of the B data (corresponding to a range of values from 128-255) embedded as the UV data. The deframing module 416 may extract the R data, G data, as well as the top half and the bottom half of the B data based on the timestamp associated with the corresponding NV12 frames 508. These top and the bottom halves of the B data are combined to have the full range of values 0-255 for the blue color component.

The obtained R data, G data, and the B data may be sent to the frame assembler 414, which may be configured to assemble the obtained data for generating a video frame in the RGB24 format signal 504 with each color component, namely, red, green, and blue having 8 bpp of data. The generated RGB video frame may be de-multiplexed by the multiplexer/de-multiplexer 409 to extract the audio data from the video data for processing and broadcasting to a display such as a target device 104.

The video splitter 406, the framing module 408, the deframing module 416, and the frame assembler 414 may be implemented in hardware or a suitable combination of hardware and software, and may comprise one or more software systems operating on a digital signal processing platform.

The “hardware” may comprise a combination of discrete components, an integrated circuit, an application-specific integrated circuit, a field programmable gate array, a digital signal processor, or other suitable hardware. The “software” may comprise one or more objects, agents, threads, lines of code, subroutines, separate software applications, two or more lines of code or other suitable software structures operating in one or more software applications or on one or more processors.

Exemplary embodiments are intended to cover all software or computer programs capable of performing the various heretofore-disclosed determinations, calculations, etc., for the disclosed purposes. For example, exemplary embodiments are intended to cover all software or computer programs capable of enabling processors to implement the disclosed processes. In other words, exemplary embodiments are intended to cover all systems and processes that configure a document operating system to implement the disclosed processes. Exemplary embodiments are also intended to cover any and all currently known, related art or later developed non-transitory recording or storage mediums (such as a CD-ROM, DVD-ROM, hard drive, RAM, ROM, floppy disc, magnetic tape cassette, etc.) that record or store such software or computer programs. Exemplary embodiments are further intended to cover such software, computer programs, systems and/or processes provided through any other currently known, related art, or later developed medium (such as transitory mediums, carrier waves, etc.), usable for implementing the exemplary operations disclosed above.

In accordance with the exemplary embodiments, the disclosed method may be executed in many exemplary ways, such as an application that is resident in the memory of a device or as a hosted application that is being executed on a server and communicating with the device application or browser via a number of standard protocols, such as TCP/IP, HTTP, XML, SOAP, REST, JSON and other sufficient protocols. The disclosed computer programs can be written in exemplary programming languages that execute from memory on the device or from a hosted server, such as BASIC, COBOL, C, C++, Java, Pascal, or scripting languages such as JavaScript, Python, Ruby, PHP, Perl or other sufficient programming languages.

To summarize, one exemplary embodiment comprises a method for encoding a video signal in RGB24 format, where the video signal has multiple RGB frames, is provided. Each RGB frame comprises 8 bits per pixel for red, green, and blue color components. The video signal may be received from a source device. The method comprises receiving at least one RGB frame from the multiple RGB frames. The at least one RGB frame may split into R data for the red color component, G data for the green color component, and B data for the blue color component.

The method further comprises converting the received at least one RGB frame into a first YUV frame and a second YUV frame, in which the R data may be embedded as a Y data of the first YUV frame, the G data may be embedded as a Y data of the second YUV frame, and the B data may be segmented into a first data segment having 0-127 values of the blue color component and a second data segment having 128-255 values of the blue color component. The first data segment may be embedded as a UV data of the first YUV frame and the second data segment may be embedded as a UV data of the second YUV frame. The method also comprises encoding the first YUV frame and the second YUV frame based on a timestamp same as that associated with the at least one RGB frame.

Another exemplary embodiment provides a non-transitory computer readable medium storing a program causing a computer to execute a process for encoding a video signal in RGB24 format having multiple RGB frames. Each RGB frame comprises 8 bits per pixel for red, green, and blue color components. The video signal may be received from a source device. The process comprises receiving at least one RGB frame from the multiple RGB frames. The at least one RGB frame may be split into R data for the red color component, G data for the green color component, and B data for the blue color component.

The process further comprises converting the received at least one RGB frame into a first YUV frame and a second YUV frame, in which the R data may be embedded as the Y data of the first YUV frame, the G data may be embedded as the Y data of the second YUV frame, and the B data may be segmented into a first data segment having 0-127 values of the blue color component and a second data segment having 128-255 values of the blue color component. The first data segment may be embedded as a UV data of the first YUV frame and the second data segment may be embedded as a UV data of the second YUV frame. Further yet, the method comprises encoding the first YUV frame and the second YUV frame based on a timestamp same as that associated with the at least one RGB frame.

Still another embodiment comprises a system for encoding a video signal in RGB24 format having a plurality of RGB frames may be provided. Each of the plurality of RGB frames comprises 8 bits per pixel for red, green, and blue color components. The system may comprise a source device, a Chroma-based video converter, and a target device. The source device provides the video signal for being encoded. The Chroma-based video converter comprises a frame splitter, a framing module, an encoder, and a multiplexer. The frame splitter may be configured to receive at least one RGB frame from the plurality of RGB frames. The frame splitter may split the at least one RGB frame into R data for the red color component, G data for the green color component, and B data for the blue color component. The framing module may be configured to convert the received at least one RGB frame into a first YUV frame and a second YUV frame in which the R data may be embedded as the Y data of the first YUV frame, the G data may be embedded as the Y data of the second YUV frame, and the B data may be segmented into a first data segment having 0-127 values of the blue color component and a second data segment having 128-255 values of the blue color component. The first data segment may be embedded as a UV data of the first YUV frame and the second data segment may be embedded as a UV data of the second YUV frame. The encoder may be configured to encode the first YUV frame and the second YUV frame based on a timestamp same as that associated with the at least one RGB frame. The multiplexer may be configured to multiplex the encoded first YUV frame and the encoded second YUV frame to generate a single encoded signal. The target device may be configured to at least one of receive, store and display the generated single encoded signal.

The Chroma-based video converter may further comprise of a deframing module and a frame assembler. The deframing module may be configured to (1) extract the Y data corresponding to the R data and the first data segment corresponding to 0-127 values of the B data from the first YUV frame; (2) extract the Y data corresponding to the G data and the second data segment corresponding to 128-255 values of the B data from the second YUV frame; (3) combine the extracted first data segment and the second data segment to obtain a complete B data; and (4) assemble the extracted R data, the extracted G data, and the complete B data based on the timestamp to generate the at least one RGB frame.

Still another aspect of the present disclosure comprises the first YUV frame being identical to the second YUV frame.

Yet another aspect of the present disclosure comprises both the first YUV frame and the second YUV frame being in NV12 format.

The above description does not provide specific details of manufacture or design of the various components. Those of skill in the art are familiar with such details, and unless departures from those techniques are set out, techniques, known, related art or later developed designs and materials should be employed. Those in the art are capable of choosing suitable manufacturing and design details.

The terminology used herein is for the purpose of describing particular embodiments only and is not intended to be limiting of the disclosure. It will be appreciated that several of the above-disclosed and other features and functions, or alternatives thereof, may be combined into other systems or applications.

Other embodiments of the present invention will be apparent to those skilled in the art after considering this disclosure or practicing the disclosed invention. The specification and examples above are exemplary only, with the true scope of the present invention being determined by the following claims.

I claim the following invention:

1. A method for encoding a video signal in RGB24 format, wherein the video signal comprises a plurality of RGB frames, each of the plurality of RGB frames having 8 bits per pixel for red, green, and blue color components, the video signal being received from a source device, comprising:
receiving at least one RGB frame from the plurality of RGB frames, wherein the at least one RGB frame is split into R data for the red color component, G data for the green color component, and B data for the blue color component;
converting the received at least one RGB frame into a first YUV frame and a second YUV frame, wherein
the R data is embedded as a Y data of the first YUV frame;
the G data is embedded as a Y data of the second YUV frame; and
the B data is segmented into a first data segment having 0-127 values of the blue color component and a second data segment having 128-255 values of the blue color component, wherein the first data segment is embedded as a UV data of the first YUV frame and the second data segment is embedded as a UV data of the second YUV frame; and
encoding the first YUV frame and the second YUV frame based on a timestamp same as that associated with the at least one RGB frame.

2. The claim according to claim 1, further comprising:
extracting the Y data corresponding to the R data and the first data segment corresponding to 0-127 values of the B data from the first YUV frame;
extracting the Y data corresponding to the G data and the second data segment corresponding to 128-255 values of the B data from the second YUV frame;
combining the extracted first data segment and the second data segment to obtain a complete B data; and
assembling the extracted R data, the extracted G data, and the complete B data based on the timestamp to generate the at least one RGB frame.

3. The claim according to claim 1, further comprising multiplexing the encoded first YUV frame and the encoded second YUV frame to generate a single encoded signal.

4. The claim according to claim 1, wherein the first YUV frame and the second YUV frame are identical.

5. The claim according to claim 1, wherein the step of converting the received at least one RGB frame into a first YUV frame and a second YUV frame comprises converting the first YUV frame and the second YUV frame in NV12 format.

6. A non-transitory computer readable medium storing a program causing a computer to execute a process for encoding a video signal in RGB24 format, the video signal having a plurality of RGB frames, each of the plurality of RGB frames having 8 bits per pixel for red, green, and blue color components, the video signal being received from a source device, the process comprising:
receiving at least one RGB frame from the plurality of RGB frames, wherein the at least one RGB frame is split into R data for the red color component, G data for the green color component, and B data for the blue color component;
converting the received at least one RGB frame into a first YUV frame and a second YUV frame, wherein
the R data is embedded as a Y data of the first YUV frame;
the G data is embedded as a Y data of the second YUV frame; and
the B data is segmented into a first data segment having 0-127 values of the blue color component and a second data segment having 128-255 values of the blue color component, wherein the first data segment is embedded as a UV data of the first YUV frame and the second data segment is embedded as a UV data of the second YUV frame; and
encoding the first YUV frame and the second YUV frame based on a timestamp same as that associated with the at least one RGB frame.

7. The claim according to claim 6, further comprising:
extracting the Y data corresponding to the R data and the first data segment corresponding to 0-127 values of the B data from the first YUV frame;
extracting the Y data corresponding to the G data and the second data segment corresponding to 128-255 values of the B data from the second YUV frame;
combining the extracted first data segment and the second data segment to obtain a complete B data; and
assembling the extracted R data, the extracted G data, and the complete B data based on the timestamp to generate the at least one RGB frame.

8. The claim according to claim 6, further comprising multiplexing the encoded first YUV frame and the encoded second YUV frame to generate a single encoded signal.

9. The claim according to claim 6, wherein the first YUV frame and the second YUV frame are identical.

10. The claim according to claim 6, wherein converting the received at least one RGB frame into a first YUV frame and a second YUV frame comprises converting the first YUV frame and the second YUV frame in NV12 format.

11. A system for encoding a video signal in RGB24 format, the video signal comprising a plurality of RGB frames, each of the plurality of RGB frames having 8 bits per pixel for red, green, and blue color components, comprising:
a source device providing the video signal for being encoded;
a Chroma-based video converter receiving the video signal, wherein the Chroma-based video converter comprising:
a frame splitter configured to receive at least one RGB frame from the plurality of RGB frames, wherein the frame splitter splits the at least one RGB frame into R data for the red color component, G data for the green color component, and B data for the blue color component;
a framing module configured to convert the received at least one RGB frame into a first YUV frame and a second YUV frame, wherein—
the R data is embedded as a Y data of the first YUV frame;
the G data is embedded as a Y data of the second YUV frame; and
the B data is segmented into a first data segment having 0-127 values of the blue color component and a second data segment having 128-255 values of the blue color component, wherein the first data segment is embedded as a UV data of the first YUV frame and the second data segment is embedded as a UV data of the second YUV frame;
an encoder configured to encode the first YUV frame and the second YUV frame based on a timestamp same as that associated with the at least one RGB frame; and
a multiplexer configured to multiplex the encoded first YUV frame and the encoded second YUV frame to generate a single encoded signal; and
a target device configured to at least one of receive, store and display the generated single encoded signal.

12. The claim according to claim 11, wherein the first YUV frame and the second YUV frame are identical.

13. The claim according to claim 11, wherein the framing module is further configured to convert the first YUV frame and the second YUV frame in NV12 format.

14. The claim according to claim 11, wherein the Chroma-based video converter further comprises:
a deframing module configured to:
extract the R data corresponding to the Y data and the first data segment corresponding to 0-127 values of the B data from the first YUV frame;
extract the G data corresponding to the Y data and the second data segment corresponding to 128-255 values of the B data from the second YUV frame; and
combine the extracted first data segment and the second data segment to obtain a complete B data; and
a frame assembler configured to assemble the extracted R data, the extracted G data, and the complete B data based on the timestamp to generate the at least one RGB frame.

15. The claim according to claim 11, further comprising multiplexing the encoded first YUV frame and the encoded second YUV frame to generate a single encoded signal.

16. A method to manufacture a system for encoding a video signal in RGB24 format, the video signal comprising a plurality of RGB frames, each of the plurality of RGB frames having 8 bits per pixel for red, green, and blue color components, comprising:
providing a source device providing the video signal for being encoded;
providing a Chroma-based video converter receiving the video signal, wherein the Chroma-based video converter comprising:
a frame splitter configured to receive at least one RGB frame from the plurality of RGB frames, wherein the frame splitter splits the at least one RGB frame into R data for the red color component, G data for the green color component, and B data for the blue color component;
a framing module configured to convert the received at least one RGB frame into a first YUV frame and a second YUV frame, wherein—
the R data is embedded as a Y data of the first YUV frame;
the G data is embedded as a Y data of the second YUV frame; and
the B data is segmented into a first data segment having 0-127 values of the blue color component and a second data segment having 128-255 values of the blue color component, wherein the first data segment is embedded as a UV data of the first YUV frame and the second data segment is embedded as a UV data of the second YUV frame;
an encoder configured to encode the first YUV frame and the second YUV frame based on a timestamp same as that associated with the at least one RGB frame; and
a multiplexer configured to multiplex the encoded first YUV frame and the encoded second YUV frame to generate a single encoded signal; and
a target device configured to at least one of receive, store and display the generated single encoded signal.

17. The claim according to claim 16, wherein the first YUV frame and the second YUV frame are identical.

18. The claim according to claim 16, wherein the framing module is further configured to convert the first YUV frame and the second YUV frame in NV12 format.

19. The claim according to claim 16, wherein the Chroma-based video converter further comprises:
a deframing module configured to:
extract the R data corresponding to the Y data and the first data segment corresponding to 0-127 values of the B data from the first YUV frame;
extract the G data corresponding to the Y data and the second data segment corresponding to 128-255 values of the B data from the second YUV frame; and
combine the extracted first data segment and the second data segment to obtain a complete B data; and
a frame assembler configured to assemble the extracted R data, the extracted G data, and the complete B data based on the timestamp to generate the at least one RGB frame.

20. The claim according to claim 16, further comprising multiplexing the encoded first YUV frame and the encoded second YUV frame to generate a single encoded signal.
